(19) United States
(12) Patent Application Publication
(10) Pub. No.: US 2009/0239733 A1
(43) Pub. Date: Sep. 24, 2009

(54) Methods of heat-treating soda-lime glass substrates and heat-treated soda-lime glass substrates formed using the same

(76) Inventors: Se-Ah Kwon, Seoul (KR); Min Kang, Seoul (KR); Byoung-Joo kim, Anyang-si (KR); Jin-Ho Ju, Seoul (KR); Chul Huh, Yongin-si (KR); Sang-Woo Whangbo, Seoul (KR)

Correspondence Address: Haynes and Boone, LLP;IP Section, 2323 Victory Avenue, SUITE 700, Dallas, TX, 75219, US

(21) Appl. No.: 12/381,207

(22) Filed: Mar. 9, 2009

(30) Foreign Application Priority Data
Mar. 21, 2008 (KR) 10-2008-26493

(51) Int. Cl. C03C 3/04; C03B 29/00

(52) U.S. Cl. 501/53; 65/28

(57) ABSTRACT

A soda-lime glass substrate formed through a heat-treatment method has an absorption coefficient ranging from about 0.15 λ,W/m·K to about 0.54 λ,W/m·K, and a free path length ranging from about 0.12 cm to about 0.24 cm. The heat-treated soda-lime glass substrate is formed by heating for a selected time at a pre-specified maximum temperature of about 270° C. to about 330° C. so as to remove thermally induced residual deformations from the substrate and then the substrate is slowly cooled so as to substantially avoid reintroducing thermally induced residual deformations into the cooling substrate. Thus, the soda-lime glass substrate is transformed to one at or close to its contraction saturation point. This allows the heat-treated soda-lime glass substrate to serve in a practical way as a substrate of a flat display panel.

### PRIORITY STATEMENT

This application claims priority under 35 U.S.C. § 119 to Korean Patent Application No. 2008-26493, filed on Mar. 21, 2008 in the Korean Intellectual Property Office (KIPO), the contents of which application are herein incorporated by reference in their entirety.

### BACKGROUND

1. Field of Invention

The present disclosure of invention relates to methods of heat-treating soda-lime glass substrates and heat-treated soda-lime glass substrates formed using the same, where the heat-treated soda-lime glass substrates are to serve as substrates for a flat panel display.

2. Description of Related Technology

As an example of a flat panel display, liquid crystal display (LCD) panel typically includes a lower glass-containing substrate, an upper glass-containing substrate, and a liquid crystal layer interposed between the lower and upper substrates. The lower substrate, which is sometimes referred to as a TFT array substrate, includes a first glass substrate, a plurality of pixel electrodes disposed on the first glass substrate, a plurality of switching elements connected to respective ones of the pixel electrodes, and crossing gate and data lines which connect to the switching elements. The upper substrate, which is sometimes referred to as a color filter substrate, includes a second glass substrate, color filters disposed on the second glass substrate, a common electrode, etc.

During device fabrication, when forming the switching elements (e.g., thin-film transistors or TFT's), the gate and data lines, the color filters, etc. and other elements of the LCD device on the respective first and second glass substrates, various processing methods such as photolithography, photo etching, vapor deposition, sputtering, laminating, photo paste, sand blast, etc. are used.

Many if not all of the above device fabricating or processing methods are performed at a process temperature in the range of about 200° C. to about 400° C. Thus, thermal deformations may be caused to occur to elements of the LCD that are already present including to the first and second glass substrates. Particularly, since the glass substrates are always present to serve as a base for the other elements of the respective upper and lower substrates, if the size or shape of the glass substrate permanently changes as result of residual thermal deformations left in it, either before or after a device fabricating process step, a large alignment error may occur between the lower substrate and the upper substrate or respective elements thereon. This alignment error may fatally deteriorate the product quality of the LCD panel.

Accordingly, in order to avoid fatal thermal deformations, a high-quality glass substrate such as a borosilicate glass substrate, whose thermally-induced deformations tend to be very small, and whose chemical and mechanical characteristics tend to be excellent, is usually employed as the glass substrate. However, high-quality glass substrates such as borosilicate glass substrates tend to be very expensive and this increases the cost of the LCD product.

Thus, there is desire to be able to mass produce one or both of the lower substrate and the upper substrate of a flat panel display by using an inexpensive glass substrate, for example, a soda-lime glass substrate.

However, as implied above, the coefficient of thermal expansion (COTE) of a conventional soda-lime glass substrate is at least two times greater than that of a standard borosilicate glass substrate. Thus, the conventional soda-lime glass substrate exhibits relatively high thermal deformations as compared to the low-COTE borosilicate glass substrate.

### SUMMARY

According to one aspect of the present disclosure of invention, a heat-treated soda-lime glass substrate is provided where it having been subjected to heat-treatment may be evidenced by it having an absorption coefficient ranging from about 0.15 λ,W/m·K to about 0.54 λ,W/m·K, and a free path length ranging from about 0.12 cm to about 0.24 cm. The absorption coefficient is defined by a ratio between incident light energy and absorbed light energy expressed by percent, where light passing through a sample has its wavelength continuously changed so as to determine absorption across a spectrum. The free path length is defined by a mean moving distance of a particle until the particle collides with another particle.

According to one aspect of the present disclosure, a soda-lime glass substrate as obtained from a conventional glass mass production plant is heat treated so as to exhibit a first thermal deformation coefficient (COTEX) that is smaller than or equal to about 0.5 ppm when measured in the width dimension of the substrate and so as to exhibit a second thermal deformation coefficient (COTEy) that is smaller than or equal to about 0.1 ppm when measured in the length dimension of the substrate. In one embodiment, these relatively small COTEx and COTEy factors corresponding to a thermal contraction saturation point (Xs) of the glass material.

According to another aspect, there is provided a method of heat-treating a soda-lime glass substrate. In the method, the soda-lime glass substrate is uniformly heated across its major surfaces for a selected time to a predefined maximum temperature, for example to between about 270° C. and about 330° C. to thereby form a thermally relaxed soda-lime glass substrate.

In an example embodiment, the soda-lime glass substrate heat-treated for the selected time is slowly cooled uniformly across its major surfaces toward a normal temperature where the slow cooling rate is selected to reduce accumulation of residual thermal stress due to the cooling. In order to cool the soda-lime glass substrate to the normal temperature in one embodiment, the soda-lime glass substrate having the maximum temperature is firstly cooled very to a slow cooling temperature above normal temperature where the slow cooling rate is such that a residual thermal deformation in the cooling glass is less than or equal to about 5% of a thermal deformation at the maximum temperature, and then the firstly slowly cooled soda-lime glass substrate is secondly cooled at a greater cooling speed than a speed of the first cooling to the normal temperature. As result of stress relaxation that occurs at the maximum temperature (Tmax), and as a result of strain reduction that occurs during the first slow cooling, after the second faster cooling; the heat-treated glass tends to be more contracted than it was before performing the heat treatment. In one embodiment, the soda-lime glass substrate is secondly cooled sufficiently slowly so that it contracts to a contraction saturation point (Xs) of its material, below which the material of the soda-lime glass substrate cannot be further contracted while at normal temperature.

The slow cooling target temperature corresponds to a temperature at which a residual thermal deformation of the glass becomes smaller than or equal to about 5% of a thermal deformation generated from heating the glass from normal to the maximum temperature, whereafter the glass substrate is rapidly cooled from the slow cooling target temperature to the normal temperature.

The slow cooling target temperature may range from about 240° C. to about 260° C. The selected time for reaching the target temperature may range from about 5 minutes to about 10 min. That is, the maximally heated soda-lime glass substrate may be firstly slowly cooled for about 5 min to about 10 min before rapid cooling is undertaken.

The soda-lime glass substrate may be rapidly heated to the maximum temperature, then firstly slowly cooled to the target temperature, and thereafter secondly rapidly cooled, where heating and cooling take place in different heat treatment chambers and the chambers have means for assuring that a uniform heating or cooling temperature is applied uniformly to one or both of the major surfaces of the soda-lime glass substrate.

In an example embodiment, before heat-treating the soda-lime glass substrate for the selected time, the soda-lime glass substrate may be maintained at a preparation temperature, and a temperature of the soda-lime glass substrate maintained at the preparation temperature may be raised monotonically to the maximum temperature. The preparation temperature may range from the normal temperature to about 100° C.

The temperature of the prepared soda-lime glass substrate may be raised for about 10 min to about 15 min from the preparation temperature to the predefined maximum temperature. The soda-lime glass substrate may be temperature-raised to the preparation temperature and then heat-treated for the selected time in the same heat chamber at the predefined maximum temperature. The soda-lime glass substrate may be heat-treated by making contact with one or more uniform heat transfer plates disposed in the heat treatment chamber so that a uniform heating or cooling temperature is applied uniformly to and across one or both of the major surfaces of the soda-lime glass substrate.

As a result of the heat-treatment applied to the soda-lime glass substrate according to one embodiment of the present disclosure, residual thermal deformation present in the soda-lime glass substrate is reduced to a level lower than present before the heat-treatment is begun. As a result, and the soda-lime glass substrate contracts closer to a contraction saturation point of its material. Thus, a lower substrate and an upper substrate, for example, a thin-film transistor (TFT) substrate and a color filter substrate may be manufactured by using the soda-lime glass substrate formed through the heat-treatment for the soda-lime glass substrate, with the size of the soda-lime glass substrate being almost constant before and after each device fabrication manufacturing process because the glass substrate returns to being at or close to its contraction saturation point after each fabrication manufacturing process.

Thus, an inexpensive soda-lime glass substrate may practically used as a lower substrate and an upper substrate of a liquid crystal display panel without fear that its higher COTE parameters will result in fatal misalignments.

In addition, the maximum temperature is around the 300° C. through the heat-treatment for the soda-lime glass substrate, which is relatively not high temperature. Thus, equipment such as the heat chamber, the quartz plate, etc. employed in the heat-treatment may be relatively inexpensive.

### BRIEF DESCRIPTION OF THE DRAWINGS

The above and other features and advantages of the present disclosure of invention will become more apparent by describing in detailed example embodiments thereof with reference to the accompanying drawings in which:

FIG. 1 is a graph illustrating an absorption coefficient of a soda-lime glass substrate that has been treated in accordance with various heat treatments;

FIG. 2 is a graph illustrating a free path length of a soda-lime glass substrate that has been treated in accordance with various heat treatments;

FIG. 3 is a flowchart illustrating a method of heat-treating an original soda-lime glass substrate according to an example embodiment;

FIG. 4 is a block diagram illustrating an example of an equipment implementing the method of heat-treating the original soda-lime glass substrate as flow charted in FIG. 3;

FIG. 5 is a graph illustrating heat-treatment condition for a temperature of the original soda-lime glass substrate heat-treated through first, second, third and fourth heat chambers in accordance with time;

FIG. 6 is a strain indicating graph illustrating different thermal deformation states of the soda-lime glass substrate as a result of each heat-treatment step;

FIG. 7 is a two-dimensional image illustrating a residual thermal deformation of the original soda-lime glass substrate before heat-treatment;

FIG. 8 is a two-dimensional image illustrating a residual thermal deformation of the soda-lime glass substrate after heat-treatment; and

FIG. 9 is a graph illustrating a thermal deformation of a thin-film transistor (TFT) substrate employing the soda-lime glass substrate heat-treated according to various conditions.

### DETAILED DESCRIPTION

The present disclosure of invention is described more fully hereinafter with reference to the accompanying drawings, in which example embodiments are shown. The disclosed concepts may, however, be embodied in many different forms and should not be construed as limited to the example embodiments set forth herein. Rather, these example embodiments are provided so that this disclosure will convey a wider scope of enabled concepts to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention most closely pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure of invention will be explained in detail with reference to the accompanying drawings.

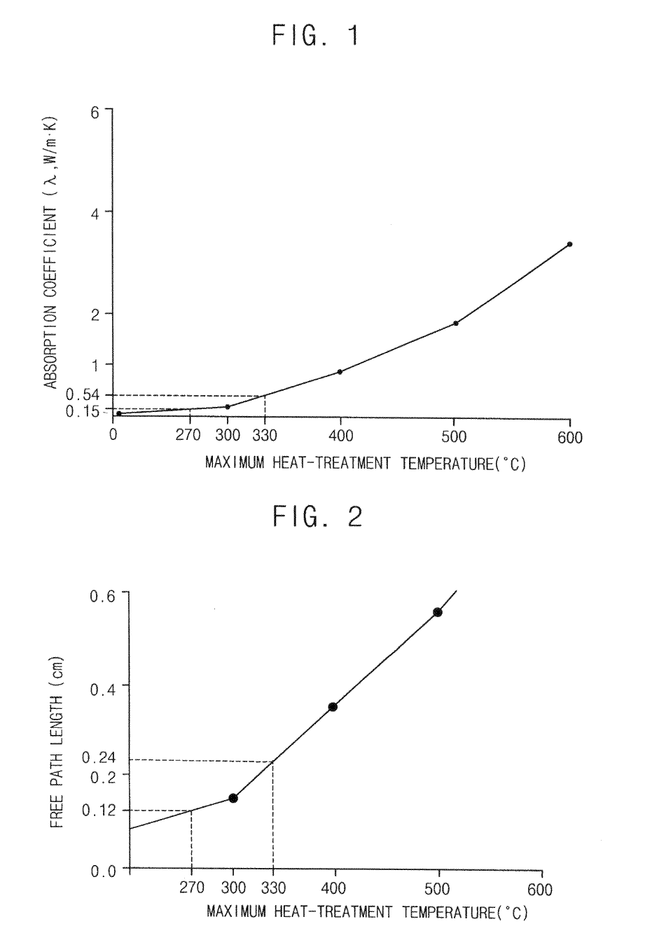

FIG. 1 is a graph illustrating an absorption coefficient of a soda-lime glass substrate in accordance with maximum temperatures of various heat treatments. FIG. 2 is a graph illustrating a free path length of a soda-lime glass substrate in accordance with maximum temperatures of various heat treatments.

A pre-treated soda-lime glass substrate is defined as a glass substrate that is to be used in fabricating an LCD or other flat panel device where the pre-treated soda-lime glass substrate is formed by heat-treating an original not yet heat-treated soda-lime glass substrate. More specifically, the original soda-lime glass substrate is one that is conventionally received from a mass production glass factory that produces soda-lime glass sheets for general applications as opposed to being produced especially for use in flat panel displays.

The graph illustrated in FIG. 1 has a horizontal axis corresponding to a heat-treatment temperature applied to an original soda-lime glass substrate and a vertical axis corresponding to a resulting absorption coefficient after the heat-treatment.

When electromagnetic radiation in ultraviolet rays (UV) area corresponding to a wavelength of about 190 nm to about 400 nm and light in the visible area corresponding to a wavelength of about 400 nm to about 900 nm passes through a material, the electromagnetic radiation partially loses energy due to change in electron states of the material, which is represented as “absorption.”

Absorption of ultraviolet rays and of visible rays provides information about a functional chemical group and/or an atom group present in the glass and operating to absorb light. In order to identify the specific wavelengths at which substantial absorption occurs, light is passed through a sample while the wavelength is continuously changed. Thus, light intensity before and after light passes through the sample is obtained for each of plural wavelengths, from which an absorption coefficient is defined as a ratio between incident light energy and absorbed light energy expressed by percent.

The graph illustrated in FIG. 2 has a horizontal axis corresponding to a heat-treatment temperature applied to an original soda-lime glass substrate and a vertical axis corresponding to a resultant free path length after the heat-treatment.

Until one particle begins to collide with neighboring particles, a mean moving distance of the one particle is defined as its free path length.

As seen from the absorption coefficient and the free path length graphs illustrated in FIGS. 1 and 2, considerable difference occurs before and after heat-treatment of the original soda-lime glass substrate.

In accordance with one embodiment, a heat-treated soda-lime glass substrate has an absorption coefficient of about 0.15 λ,W/m·K to about 0.54 λ,W/m·K, and a free path length of about 0.12 cm to about 0.24 cm. An original soda-lime glass substrate has an absorption coefficient less than about 0.15 λ,W/m·K and a free path length less than about 0.12 cm.

Accordingly, when the absorption coefficient and the free path length of a given soda-lime glass sample are measured, it can generally be determined whether or not the soda-lime glass sample is an original soda-lime glass substrate or is a heat-treated substrate formed through the heat-treatment process of the present disclosure.

It has been found that thermal deformation tends to be very small and almost ignorable when original soda-lime glass substrate is heat-treated under a process temperature of about 200° C. to about 400° C. and then cooled to an initial temperature (e.g. room temperature) such that the heat-treated soda-lime glass substrate has an absorption coefficient of about 0.15 λ,W/m·K to about 0.54 λ,W/m·K, and a free path length of about 0.12 cm to about 0.24 cm.

It has been found that when the absorption coefficient of the soda-lime glass substrate is smaller than about 0.15 or greater than about 0.54, and the free path length of the soda-lime glass substrate is smaller than about 0.12 or greater than about 0.24, the thermal deformation of the soda-lime glass substrate tends to be so great that the soda-lime glass substrate may not be suitable to serve as a substrate for a display panel.

Even though the soda-lime glass substrate according to an example embodiment of the present disclosure is heat-treated under a process temperature of about 200° C. to about 400° C., it has been found that a thermal deformation is smaller than about 0.5 ppm in width and smaller than about 0.1 ppm in length if the heat-treatment is carried out on a basis of a contraction saturation point when the soda-lime glass substrate is cooled to an initial temperature.

Thus, when a heat-treated soda-lime glass substrate according to an example embodiment serves as a base substrate of a thin-film transistor (TFT) substrate or a color filter substrate for a liquid crystal display (LCD) panel, an arrangement error between the TFT substrate and the color filter substrate due to a thermal deformation may be reduced.

Hereinafter, a method of heat-treating an original soda-lime glass substrate according to an example embodiment will be described.

In a method of heat-treating an original soda-lime glass substrate according to an example, the original soda-lime glass substrate is heat-treated for a selected time at a temperature of about 200° C. to about 400° C., preferably about 270° C. to about 330° C. to form a heat-treated soda-lime glass substrate. Before heat-treating the original soda-lime glass substrate at the maximum applied temperature, the original soda-lime glass substrate is maintained at a preparation temperature, and then temperature-raised to the maximum applied temperature as shown for example in FIG. 5. The original soda-lime glass substrate may be cooled to a normal temperature (e.g., room temperature) after heat-treating at the maximum temperature.

Hereinafter, a method of heat-treating the original soda-lime glass substrate according to an example embodiment will be described in yet more detail.

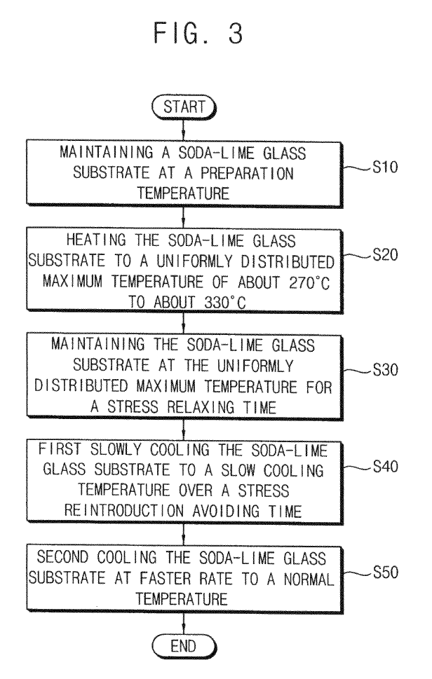

FIG. 3 is a flowchart illustrating a method of heat-treating an original soda-lime glass substrate according to an example embodiment.

Referring to FIG. 3, in a method of heat-treating an original soda-lime glass substrate, an original soda-lime glass substrate (hereinafter, referred to as original glass substrate) is maintained at a preparation temperature (step S10) which is substantially greater than room temperature for a first duration (.e.g. 5 minutes).

Then, the prepared glass substrate which has been maintained at the preparation temperature is heated so its temperature rises monotonically (e.g., over a duration of about 10 minutes) to have a maximum temperature of about 270° C. to about 330° C. (step S20).

Thereafter, the maximally heated glass substrate (heated to the maximum temperature) is maintained at that maximum temperature for a third duration (e.g., about 10 minutes), a during which a residual thermal deformation in the original glass substrate incurred due to thermal stress of rising to the maximum temperature may be reduced (step S30).

Then, the maximally heated glass substrate in which the residual thermal deformation has been reduced by waiting the third duration, is cooled over a fourth duration from the maximum temperature to a slow cooling temperature so that a new residual thermal deformation will not be generated as glass substrate drops in temperature (step S40).

Finally, the slowly cooled glass substrate may be rapidly cooled to a normal temperature such that the treated substrate will be more contracted than before performing the heat treatment (step S50).

Hereinafter, each step of the method of heat-treating the original glass substrate will be described in yet more detail.

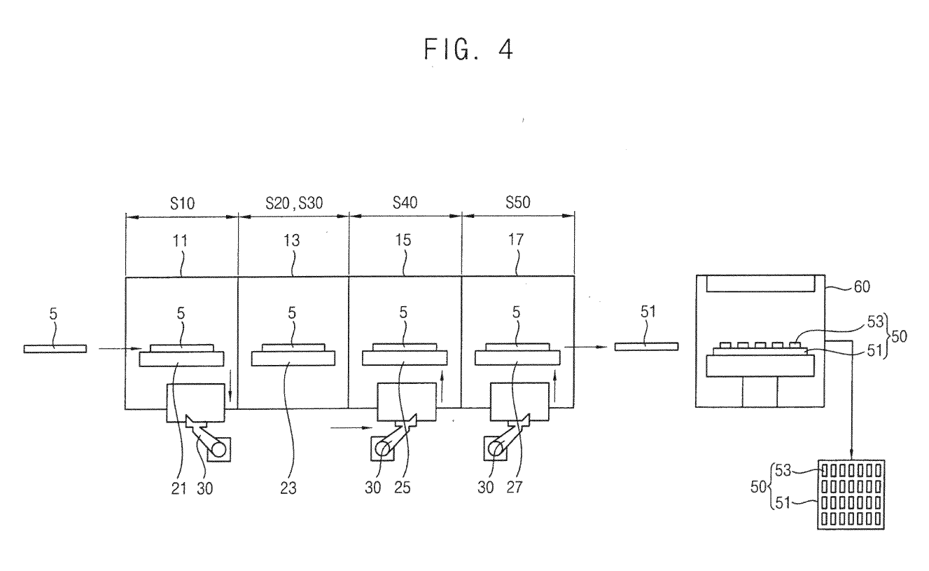

FIG. 4 is a block diagram illustrating an example of equipment implementing the method of heat-treating the original glass substrate in accordance with FIG. 3.

An equipment for heat-treating the original glass substrate may be variously modified. The equipment illustrated in FIG. 4 is just an example so as to explain the method of heat-treating the original glass substrate in detail, and thus the method of heat-treating the original glass substrate is not limited by the equipment illustrated in FIG. 4.

Referring to FIG. 4, an original glass substrate 5 is successively advanced through a plurality of heat chambers 11, 13, 15 and 17 and the steps of the heat-treatment are sequentially performed in these chambers. For example, the first, second, third and fourth heat chambers 11, 13, 15 and 17 are illustrated in FIG. 4. Transferring units 30, for example, robot arms 30 may be disposed at the first, second, third and fourth heat chambers 11, 13, 15 and 17 to carry the glass substrate 5 in or out of the heat chambers.

Each of the first, second, third and fourth heat chambers 11, 13, 15 and 17 may correspond to a separate closed heat chamber. Alternatively, the first, second, third and fourth heat chambers 11, 13, 15 and 17 may be successively open and connected, and the original glass substrate 5 is disposed on a conveyor and transferred therethrough. Here, the original glass substrate 5 may be radiatively heated by using a radiative device, for example, such as a tungsten halogen lamp.

In an exemplary embodiment, first, second, third and fourth heat transfer plates 21, 23, 25 and 27, for example, such as a quartz plate may be disposed in the first, second, third and fourth heat chambers 11, 13, 15 and 17, respectively. Quartz is a crystallized silicon oxide similar to porcelain used in a crucible in which ceramic is burnt, and it may be heated at high temperature without breakage. The original glass substrate 5 is disposed on the quartz plate, and has thermal equilibrium with the quartz plate, for example, by convection, so that the temperature of the original glass substrate 5 may be controlled.

FIG. 5 is a graph illustrating heat-treatment condition for a temperature of the original glass substrate heat-treated through first, second, third and fourth heat chambers in accordance with time;

Referring to FIGS. 4 and 5, firstly, the original glass substrate 5 is disposed in the first heat chamber 11, and maintained at a preparation temperature T0 (step S10).

The first heat chamber 11 has an interface to receive a cassette containing the original glass substrate 5 and moving along a heat chamber line. Before preparation heating of the original glass substrate 5, the temperature of the original glass substrate 5 may be uniform.

The first heat chamber 11 may be maintained at the preparation temperature T0, for example, normal temperature Te to a temperature of about 100° C., before heating the original glass substrate 5. The normal temperature Te indicates a natural temperature, not artificially heated or cooled, for example, about 15° C.

Then, the original glass substrate 5 maintained at the preparation temperature T0 is heated to a maximum temperature Tmax of about 270° C. to about 330° C. (step S20).

Thus, the original glass substrate 5 is transferred from the first heat chamber 11 to the second heat chamber 13 by the transferring unit 30, and disposed on the second quartz plate 23 in the second heat chamber 13. The original glass substrate 5 is heated to the maximum temperature Tmax of about 270° C. to about 330° C. in the second heat chamber 13.

For example, the second quartz plate 23 is at the maximum temperature Tmax, and the original glass substrate 5 makes contact with the second quartz plate 23 to be heated, so that the original glass substrate 5 has thermal equilibrium with the second quartz plate 23.

The second quartz plate 23 heats the original glass substrate 5 for at least about 10 minutes to be sufficient for heat-transferring to the original glass substrate 5. The original glass substrate 5 may be slowly heated for greater than or equal to about 10 min so as to prevent thermal shock to the original glass substrate 5, and may be heated for smaller than or equal to about 15 min so as to prevent unnecessary increase in process time.

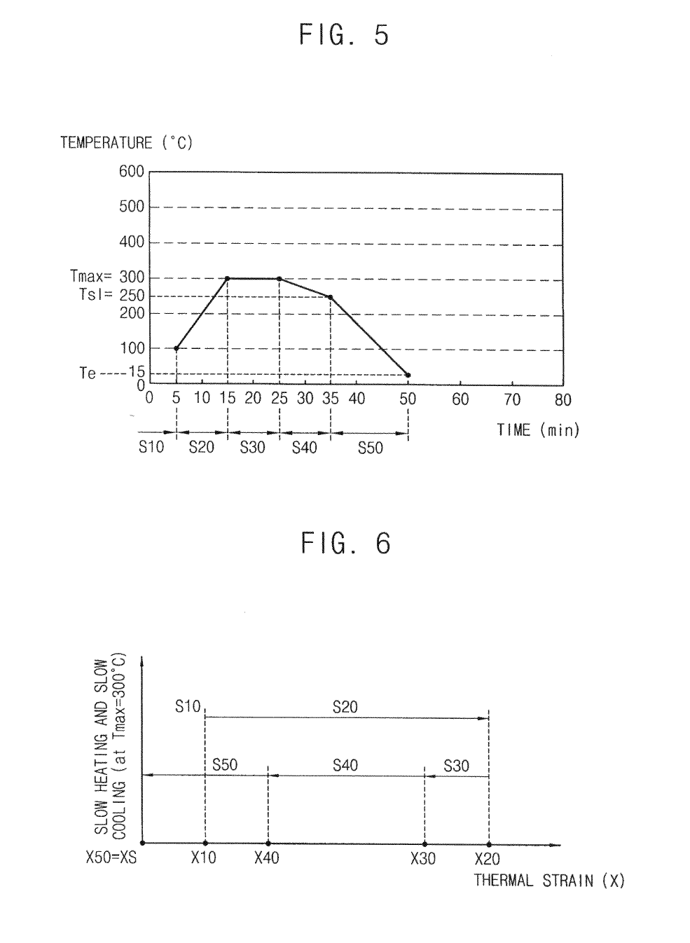

FIG. 6 is a graph illustrating a cycle of thermal strains applied to the original soda-lime glass substrate as it progresses through each heat-treatment step. In FIG. 6, length of a horizontal axis of the graph corresponds to magnitude of linear expansion (strain), and reference numerals S10, S20, S30, S40 and S50 represents for each step of the heat-treatment.

Referring to FIG. 6, an object typically expands or contracts according to temperature variation, and when the expansion or contraction is obstructed in a portion of the object due to some factors, a portion of the object is compressed or stretched by the obstructed strain, so that nonuniform strain occurs and an internal stress is generated within the object. The strain and stress is named as a residual thermal deformation and a residual thermal stress, respectively. The fact that thermal stress is residual within an object represents that a residual thermal deformation exists within the object due to its past history of heating and cooling cycles and the differences of heating and cooling in different regions of the object.

When an object is non-uniformly heated, expansion rate and contraction rate of the object varies according to locations. Thus, portions having different temperatures obstruct a thermal deformation with respect to each other as described above, so that after cooling thermal stress is residual within the object. Hence, if the object (a homogenous object like a glass sheet) is uniformly maintained over its entire body for a selected time at a temperature at which the thermal stress is generated, the thermal stress may be substantially reduced or removed. In other words, when the object is uniformly heated for a selected time, uniform thermal deformation is realized throughout the object to uniformly change the size of the object.

An object, whose thermal stress is not residual therein, expands due to heating, and can then recover to an initial size due to cooling to an initial temperature. However, in an object having thermal stress pre-existing therein, thermal stress may be reduced and thermal deformation is realized by a method of uniform heating and isothermal maintenance as described above. Thus, when the object is cooled to an initial temperature, the size of the object varies, and in case of the original glass substrate 5, the size thereof contracts.

Referring to FIGS. 4, 5 and 6, the original glass substrate 5 is maintained at the preparation temperature TO in the first heat chamber 1, and a thermal deformation X of the original glass substrate 5 represents various intervals or distances from a contraction saturation point Xs including the spaced apart initial residual strain point X10. The contraction saturation point Xs is defined by a point at which the glass substrate 5 does not further contract in response to additional cooling.

The thermal deformation of the original glass substrate 5 after it has been heated to the maximum temperature Tmax of about 270° C. to about 330° C. in the second heat chamber 13, is represented by the maximum strain point X20 in FIG. 6.

Thereafter, the original glass substrate 5 heated to the maximum temperature Tmax is maintained at the maximum temperature Tmax for a first time to reduce the residual thermal deformations within different areas of the original glass substrate 5, which relaxation of differential strains is generated at the maximum temperature Tmax (step S30).

Considering sufficient heat transfer time and process time, the first stress removal time may range from about 5 min to 10 min. The residual thermal stress present within the original glass substrate 5 at a temperature of about 200° C. to about 400° C. is reduced for the first time when realizing the uniform thermal expansion at Tmax. Thus, the thermal deformation X of the original glass substrate 5, in which residual thermal deformation is reduced, is reduced from the maximum point X20 to a first reduced strain point X30 due to thermal relaxation at Tmax.

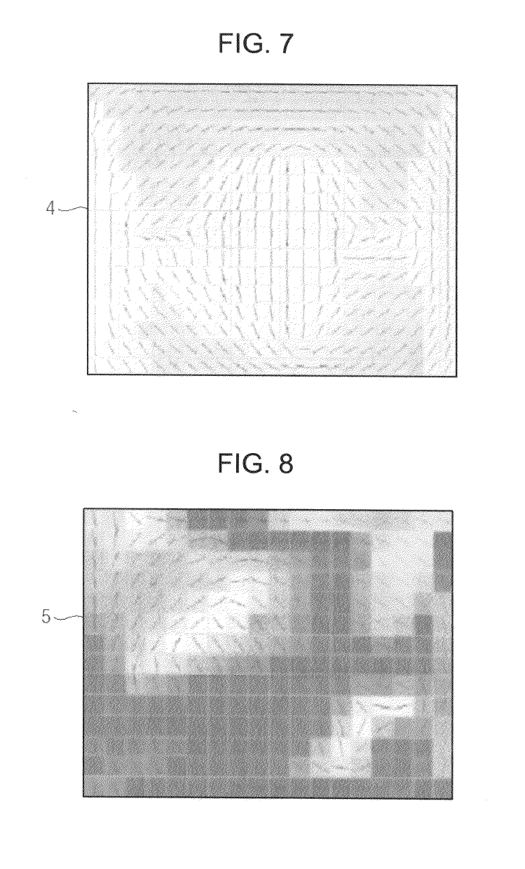

FIG. 7 is a two-dimensional image illustrating a residual thermal deformation of the original soda-lime glass substrate before heat-treatment. FIG. 8 is a two-dimensional image illustrating a residual thermal deformation of the soda-lime glass substrate after heat-treatment. In the images illustrated in FIGS. 7 and 8, the larger residual thermal deformations are represented by increased bright areas such as white representing a relatively large residual thermal deformation at the respective location.

Referring to FIGS. 7 and 8, the bright area of the image in FIG. 8 is much smaller than that of the image in FIG. 7 hence indicating that residual thermal deformation has been significantly reduced in regions that were beforehand highly stressed.

Thus, it may be surmised that the original glass substrate 5 is maintained for the first time at the maximum temperature Tmax to thereby greatly reduce the residual thermal deformation within the original glass substrate 5 as described above.

Referring to FIG. 6 and the next transition to point X40, this represents the maximally heated glass substrate 5 in which the residual thermal deformation has been reduced by thermal relaxation being firstly cooled for a second time from the maximum temperature Tmax to a slow cooling temperature Tsl so that a relatively large new residual thermal deformation is not generated within the original glass substrate 5 (step S40) due to the cooling.

Thus, the original glass substrate 5 is transferred to the third heat chamber 15 by the transferring unit 30. The third quartz plate 25 in the third heat chamber 15 is maintained at the slow cooling temperature Tsl. Hence, the original glass substrate 5 making contact with the third quartz plate 25 is uniformly cooled to the slow cooling temperature Tsl.

The slow cooling temperature Tsl corresponds to a temperature at which the residual thermal deformation within the original glass substrate 5 becomes smaller than or equal to about 5% of the thermal deformation at the maximum temperature when the original glass substrate 5 is rapidly cooled from a temperature greater than the slow cooling temperature Tsl to the slow cooling temperature Tsl, and also corresponds to a temperature at which new residual thermal deformation is not generated within the original glass substrate 5 even though the original glass substrate 5 is rapidly cooled from the slow cooling temperature Tsl to a temperature smaller than the slow cooling temperature Tsl.

According to an experimental result of an example embodiment, when the original glass substrate 5 was rapidly cooled for a time shorter than the second time to a temperature of about 240° C. to about 260° C., new residual thermal deformation generated within the original glass substrate 5 became smaller than or equal to about 5% of the thermal deformation at the maximum temperature, and new residual thermal deformation was not generated within the original glass substrate 5 at the temperature of about 240° C. to about 260° C. even though the original glass substrate 5 was rapidly cooled.

Accordingly, the slow cooling temperature Tsl of the original soda-lime glass substrate 5 may range from about 240° C. to about 260° C. In addition, the slow cooling time may range from about 5 min to about 10 min so as to slowly perform the first cooling from the maximum temperature Tmax to the slow cooling temperature Tsl. The thermal deformation X of the original glass substrate 5 firstly cooled to the slow cooling temperature Tsl corresponds to a second reduced strain point X40.

Finally, the firstly cooled original glass substrate 5 is rapidly secondly cooled to the normal temperature Te, so that the original glass substrate 5 contracts more than before the heat-treatment (step S50), to the new reduced strain point X50 which may be substantially close to or equal to the saturation strain point Xs.

Thus, the original glass substrate 5 maintained at the normal temperature Te in the fourth heat chamber 17 is disposed on the fourth quartz plate 27. Accordingly, the original glass substrate 5 is secondly cooled and contracts.

As described above, the original glass substrate 5 is maintained for the first time at the maximum temperature Tmax in the second heat chamber 13, so that the residual thermal stress is reduced and the thermal deformation is realized in the original glass substrate 5.

Thus, when the original glass substrate 5 is cooled to the normal temperature Te, the original glass substrate 5 contracts more than the initial original glass substrate 5 and the size of the original glass substrate 5 is reduced. The thermal deformation X of the secondly cooled original glass substrate 5 corresponds to a final contraction point X50 smaller than the initial point X10.

As an experimental result of heat-treating the original soda-lime glass substrate 5 according to an example embodiment of the present invention, the final contraction point X50 was similar to the contraction saturation point Xs of the original soda-lime glass substrate 5.

Thus, even though the heat-treated glass substrate 5 is afterwards used in a process at a process temperature of about 200° C. to about 400° C., since a residual thermal stress that may be exhausted at a temperature of about 200° C. to about 400° C. is already almost exhausted through the heat-treatment, the residual thermal deformation is not realized within the heat-treated glass substrate 5 when it is again heated during device fabrication. Hence, the heat-treated glass substrate 5, after fabrication expansion, contracts to an initial size again. Accordingly, the size of the heat-treated glass substrate 5 is very little varied before or after the fabrication process steps.

Referring again to FIG. 4, the heat-treated soda-lime glass substrate 5, i.e. the soda-lime glass substrate is cut and cleaned to form a base substrate 51, and then pixels 53 including TFTs are formed on the base substrate 51 by using an apparatus such as a thin-film deposition equipment 60.

Thus, the soda-lime glass substrate formed by the heat-treatment of the original soda-lime glass substrate serves as the base substrate 51 to form a TFT substrate 50. In the TFT substrate 50, after the TFTs are formed, a thermal deformation of the base substrate 51 is smaller than or equal to about 0.5 ppm in a width direction DX, and smaller than or equal to about 0.1 ppm in a length direction DY, in comparison with before the TFTs are formed, so that the thermal deformation of the base substrate 51 is very little.

Hereinafter, it is explained with reference to an experimental result that the thermal deformation of the soda-lime glass substrate formed by the heat-treatment of the original soda-lime glass substrate 5 according to an example embodiment is very little and ignorable.

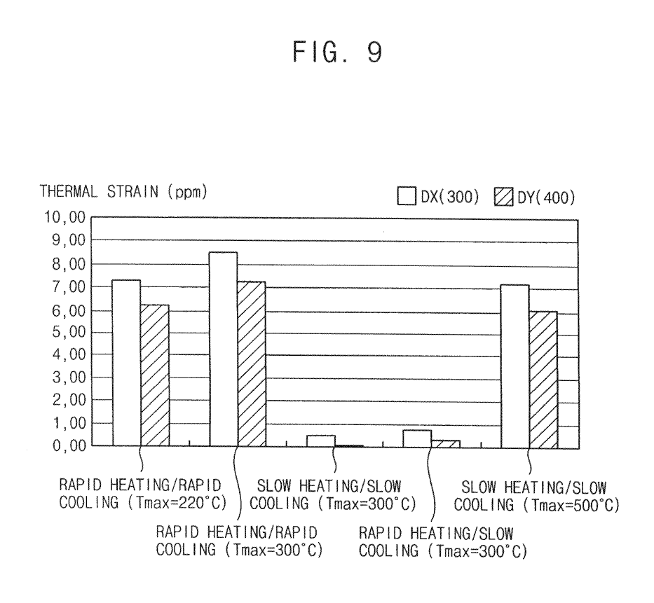

FIG. 9 is a graph illustrating a thermal deformation of a TFT substrate employing the soda-lime glass substrate heat-treated according to various conditions.

In FIG. 9, the original glass substrate is heat-treated to form the soda-lime glass substrate with various heat-treatment conditions and some variables such as a maximum temperature Tmax, a heating speed and a cooling speed, and the thermal deformation X of the soda-lime glass substrate, which serves as the base substrate of the TFT substrate, after the heat-treatment is shown.

As described in FIGS. 3 and 8, the heat-treated original soda-lime glass substrate, i.e. the soda-lime glass substrate contracts to or close to the saturation contraction point Xs.

In FIG. 9, “DX” of “DX 300” represents for an X-axis direction of the glass substrate, and “300” of “DX 300” represents that the size of the glass substrate in the X-axis direction is 300 cm. “DY” of “DY 400” represents for a Y-axis direction of the glass substrate, and “400” of “DY 400” represents that the size of the glass substrate in the Y-axis direction is 400 cm DY 400. A vertical axis of the graph corresponds to a thermal deformation X, and a unit of the thermal deformation X is ppm.

Referring to FIG. 9, the various heat-treatment conditions include a case of a rapid heating and a slow cooling with the maximum temperature Tmax of about 220° C., a case of a rapid heating and a rapid cooling with the maximum temperature Tmax of about 300° C., a case of a slow heating and a slow cooling with the maximum temperature Tmax of about 300° C. (the present embodiment), a case of a rapid heating and a slow cooling with the maximum temperature Tmax of about 300° C., and a case of a slow heating and a slow cooling with the maximum temperature Tmax of about 500° C.

The thermal deformations X of the glass substrates in the above described cases are about 7.2 ppm, about 8.5 ppm, about 0.5 ppm (the present embodiment), about 0.9 ppm and about 7.0 ppm in the DX direction, and about 6.2 ppm, about 7.1 ppm, about 0.1 ppm (the present embodiment), about 0.4 ppm and about 6.0 ppm in the DY direction.

When the original soda-lime glass substrate 5 not heat-treated, which is the original glass substrate at the time the original glass substrate is formed, is heat-treated under a process having a process temperature of about 200° C. to about 400° C., the thermal deformation is realized, so that the size of the heat-treated glass substrate is reduced by about 10 ppm in comparison with the initial size of the original glass substrate.

Thus, referring to the fact that the thermal deformation of the original soda-lime glass substrate 5 not heat-treated is about 10 ppm and the experimental result shown in FIG. 9, the thermal deformation of the glass substrate that is formed through the heat-treatment to the original glass substrate 5 according to an example embodiment of the present invention is very little.

In addition, the thermal deformation X at the maximum temperature Tmax of about 300° C. is much less than thermal deformation X at the maximum temperature Tmax of about 500° C. Thus, a higher heat-treatment temperature does not necessarily reduce the thermal deformation X. Additionally, when the maximum temperature Tmax is around 300° C., for example, about 270° C. to about 330° C. as the present embodiment, the thermal deformation X may preferably be reduced.

In addition, it may be surmised that the fact that the speed of heating of the original glass substrate is slow or fast does not greatly affect on the thermal deformation X of the glass substrate while other conditions are substantially the same.

In contrast, when the heated glass substrate is cooled to the slow cooling temperature Tsl, it may be surmised that the slow cooling may be preferable, since the thermal deformation X of the slow cooling is smaller than that of the fast cooling while other conditions are substantially the same.

When the absorption coefficient and the free path length of the soda-lime glass substrate are measured, it may be inferred whether the heat-treatment has been performed to the original soda-lime glass substrate and what the heat-treatment conditions such as the maximum temperature, the cooling speed, etc. are.

Accordingly, after the absorption coefficient and the free path length of the soda-lime glass substrate are measured, it may be determined whether the heat-treatment for the original soda-lime glass substrate according to the example embodiment of the present invention is used.

According to the soda-lime glass substrate and the method of heat-treating the original soda-lime glass substrate according to an example embodiment of the present invention, the size of the soda-lime glass substrate is almost constant before and after thermal forming steps in the device fabrication process.

Thus, an inexpensive soda-lime glass substrate may serve as a substrate of a liquid crystal display panel. In addition, equipment such as the heat chamber, the quartz plate, etc. may be relatively inexpensive.

Therefore, the soda-lime glass substrate and the method of heat-treating the original soda-lime glass substrate may be employed in forming a substrate of a display panel.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present disclosure. Accordingly, all such modifications are intended. to be included within the scope of the present invention as defined by the present disclosure. In the claims, means-plus-function clauses are intended to cover the structures described herein as performing the recited function and not only structural equivalents but also functionally equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the disclosure.

What is claimed is:

1. A heat-treated soda-lime glass substrate uniformly having:
an absorption coefficient ranging from about 0.15 λ,W/m·K to about 0.54 λ,W/m·K; and
a free path length ranging from about 0.12 cm to about 0.24 cm.

2. The soda-lime glass substrate of claim 1, wherein the soda-lime glass substrate has a thermal deformation equal to or smaller than about 0.5 ppm in a width direction and equal to or smaller than about 0.1 ppm in a length direction of the substrate.

3. A method of heat-treating a soda-lime glass substrate comprising heat-treating the soda-lime glass substrate for a selected time so that the substrate uniformly achieves across at least one of its major surfaces, a prespecified maximum temperature of about 270° C. to about 330° C. whereat relaxation of deformation stress if any in the soda-lime glass substrate takes place.

4. The method of claim 3, further comprising slowly cooling the maximally heated soda-lime glass substrate for the selected slow cooling time, where said slow cooling substantially does not introduce new deformation stresses into the soda-lime glass substrate as a result of thermal contraction.

5. The method of claim 4, wherein cooling the soda-lime glass substrate comprises:
firstly slowly cooling the soda-lime glass substrate having the maximum temperature toward a target slow cooling temperature so that a residual thermal deformation due to the slow cooling is less than or equal to about 5% of a thermal deformation produced by heating the substrate to the prespecified maximum temperature; and
secondly cooling the firstly slowly cooled soda-lime glass substrate at a cooling speed greater than the speed of the first slow cooling to thereby achieve a cooler normal temperature for the substrate.

6. The method of claim 5, wherein as a result of cooling to the normal temperature, the heat-treated soda-lime glass substrate is contracted to or substantially close to a contraction saturation point of its material, below which the material of the soda-lime glass substrate cannot further contract when at the normal temperature.

7. The method of claim 5, wherein the slow cooling target temperature ranges from about 240° C. to about 260° C.

8. The method of claim 7, wherein the selected time ranges for the slow cooling is from about 5 min to about 10 min.

9. The method of claim 8, wherein the soda-lime glass substrate is firstly cooled slowly for about 5 minutes to about 10 minutes.

10. The method of claim 5, wherein the soda-lime glass substrate is heated to the prespecified maximum temperature, firstly slowly cooled, and then secondly more rapidly cooled in different heat transfer chambers.

11. The method of claim 3, further comprising:
prior to heat-treating the soda-lime glass substrate for the selected time, maintaining the soda-lime glass substrate at a preparation temperature; and
raising a temperature of the prepared soda-lime glass substrate maintained at the preparation temperature to the maximum temperature.

12. The method of claim 11, wherein the preparation temperature ranges from the normal temperature to about 100° C.

13. The method of claim 12, wherein the temperature of the soda-lime glass substrate is raised for about 10 min to about 15 min from the preparation temperature to the maximum temperature.

14. The method of claim 11, wherein the soda-lime glass substrate is prepared, temperature-raised and heat-treated for the selected time in the same heat chamber.

15. The method of claim 14, wherein the soda-lime glass substrate is heat-treated by making thermal contact with a heat energy transferring plate disposed in the heat chamber and the heat energy transferring plate is structured to uniformly heat or cool a major surface of the soda-lime glass substrate to a specified temperature.
